(19) United States
(12) Patent Application Publication
(10) Pub. No.: US 2015/0213001 A1
(43) Pub. Date: Jul. 30, 2015

(54) Systems and Methods for Collection-Based Multimedia Data Packaging and Display

(71) Applicants: Ron Levy, Tel-Aviv (IL); Aviad Ashkenazi, Givataim (IL)

(72) Inventors: Ron Levy, Tel-Aviv (IL); Aviad Ashkenazi, Givataim (IL)

(21) Appl. No.: 14/422,197

(22) PCT Filed: Aug. 20, 2013
(86) PCT No.: PCT/IL2013/050707

§ 371 Date: Feb. 18, 2015

Related U.S. Application Data
(60) Provisional application No. 61/684,961, filed on Aug. 20, 2012.

(51) Int. Cl. G06F 17/24; H04L 12/58; G06T 11/60; H04L 29/08; G06F 17/21; G11B 27/031

(52) U.S. Cl. CPC G06F 17/248; G06F 17/212; G11B 27/031; G06T 11/60; H04L 67/06; H04L 51/32; H04L 51/04; G06T 2200/24; G06T 2210/32

(57) ABSTRACT

Systems and methods for creating an all-in-one experience by combining media (photos, videos, etc.), content (text, external feeds) and meta-data (tagged friends, location) into one interactive canvas in an automatic manner. An application of the invention can run on any user device: mobile device, personal computer, tablet, laptop, game console, or television. The system can scan user data, filter unwanted content, package it into coherent multimedia collections and display them on any user device.

### TECHNICAL FIELD

The present invention relates to data presentation in general, and in particular to systems and methods for identifying and displaying together different multimedia and content data items related to the same collection.

### BACKGROUND ART

In the digital world of today, no matter if one looks at a tablet application, surfs the web, views content on a desktop computer or mobile computer, all these environments are typically media rich. However, when one looks at a news story or a photo album on even the most advanced platforms, they all look the same as the news story on a printed paper; and an online album has the same look and feel as physical albums made years ago. There is typically little or no interactivity, little or no serendipity. There even isn't a place today where one can watch a few media items at a time, let alone pictures and videos on the same screen. There is no real way to integrate additional related information such as Twitter™ feeds, Facebook™ posts or even comments as part of the story or album itself. Moreover, rich-media albums seldom exist other than in the context of an edited video clip. They seldom live side-by-side in harmony.

The result is that news stories remain flat and non-interactive, and that web pages and media galleries on the web, mobile and tablets all look the same. The albums available today are all left for flipping image-by-images. Personal events and stories are therefore disintegrated and don't present the full scope of the story, leaving it to the user to put the pieces together.

It is believed that over 10 Billion images are uploaded monthly to social networks such as Facebook™, yet only 9 out of 10 pictures taken on a mobile phone are ever uploaded. This leaves tens of billions of images, and billions of videos, that are simply stuck on the phone. There are basically limited ways to “free” a phone from the media that is left on it:
1. Connect the device to a computer and download the media, or alternatively send the media to oneself via email or text messaging apps. This method basically means that all the sharing and editing is then done from the PC.
2. Upload media one-by-one to photo and video sharing sites such as Facebook™ or Viddy™. Creating a full experience in these sites is limited to creating an old-fashioned album.
3. Automatic cloud backup solutions that upload all the media without regarding what the user wants to see and what he doesn't (iCloud™ as an example). This type of solutions is basically intended for backup only.

None of the above solutions offer the user a one-click method for sharing an entire experience or collection, in particular one that is automatically organized. Users want to be able to share their complete personal experience and share the captured media items without going into a long and tedious uploading and editing process.

In addition, while cloud storage solutions like iCloud™ or Dropbox™ exist, they do not serve the user much beyond being a backup tool so the user will not lose his photos and videos. There is no cross-platform (mobile to/from tablet to/from web) method to view all photos and videos using the same synchronized experience.

### SUMMARY OF INVENTION

It is an object of the present invention to scan different multimedia data items and group them by collections.

It is another object of the present invention to display together multimedia data items of different types relating to the same collection.

It is a further object of the present invention to allow users to store these collections, and multimedia items, together and separately, locally or on 3^{rd} party (cloud) storage, and ensure that the collection is synchronized between all these platforms.

One of the unique features of the invention is the capability to display a mixture of different types of media and content, specifically viewing photos and videos together.

The term “multimedia” as defined herein includes media of different types including but not limited to: text, audio, drawings, photos, animations, video clips. Multimedia content can be generated by the user, created by a 3^{rd} party or derived by the system.

The present invention thus relates to a computerized, multimedia, collection-based presentation system comprising a processor and memory, comprising:

(i) a data identifier module for scanning multimedia data items on one or more devices and arranging said multimedia data in a database by collections based on predetermined collection-related parameters;

(ii) a data filtering module for removing multimedia data items that are deemed unnecessary;

(iii) a data packager module for packaging together all multimedia data items relevant to a collection; and

(iv) a display module for displaying said multimedia data items relevant to a collection according to a predetermined presentation template.

The database for storing multimedia data items can reside on a user device or on a networked storage area such as the cloud. The database can also be located on multiple locations (any combination of multiple devices and multiple network storage locations). Multimedia collections can reside on multiple locations.

In some embodiments, the multimedia data items comprise images, video clips, sound clips, text, maps, advertisements, contextually derived data or meta-data such as location or title.

In some embodiments, the data filtering module removes blurry images, duplicate images, too dark or too bright images, images or videos that are too similar, images or videos deemed unworthy or intimate or private content such as nudity, very short videos, very long videos, shaky videos, content deemed private, inappropriate or intimate, or multimedia data deemed of low quality.

In some embodiments, the collection-related parameters comprise: location where said multimedia data was captured, time when said multimedia data was captured, orientation, pattern of media capturing, tagged friends, user profile data, participant data, predetermined collections determined by the system.

In some embodiments, the presentation template comprises a plurality of tiles, each tile displaying a multimedia data item.

A “tile” as defined herein refers to a zone (sometimes referred to also as window) in the display area where content is displayed. The dimensions of the tile can vary according to the device characteristics, content display, user preferences, user selection etc.

In some embodiments, the display module is configured to display on each tile a multimedia data item for a given period of time after which another multimedia data item from the same collection is displayed on said tile.

In some embodiments, each tile can also display an advertisement, a map, the date, a time, user profile data, drawing or a sound clip.

In some embodiments, the display module is coupled to a user interface configured for changing the content, size and/or shape of a tile following a user action or based on automatic predetermined algorithm.

In some embodiments, the display module displays a multimedia data item in a tile based on analytical or statistical data regarding which presentation template gained the most interaction from a user.

In some embodiments, the interaction is measured when a user clicks on the tile, views the content of the tile, moves the tile, changes the position of the tile, selects the tile or performs any other action specific to said tile.

In some embodiments, the display module is further configured for automatically deriving a collection title of a particular multimedia data item by analyzing user related data on a device or external sources or both.

In some embodiments, the external sources are social networks, external databases or any other available data. Such data can be the user's personal data, his friends' or contacts' data or public data.

In some embodiments, the data identifier module is further configured for accessing and retrieving some or all of the multimedia data items from external sources.

In some embodiments, the presentation system further comprising a data sharing module configured to sharing multimedia data items relevant to a collection with other users.

In some embodiments, the data sharing module is configured for sharing multimedia data items relevant to a collection via email, Short Messages (SMS), Multimedia Messages (MMS), data sharing networks (such as WhatsApp™), peer-to-peer networks (such as Skype™) or social networks including through proprietary mobile applications.

In some embodiments, any or all of the functionalities of the data identifier module, data filtering module, data packaging module or data display module reside on a server connected to an application on a user device.

In some embodiments, the user device is a mobile phone, a tablet, a personal computer, a laptop, a game console, a TV set-top box or any other mobile device.

In some embodiments, the user device is networked storage location such storage location accessed over the Internet (sometimes also referred to as storage in the Cloud).

In some embodiments, the presentation system further comprises a cloud synchronization module adapted for storing multimedia data collections in the cloud such that the display module can access said multimedia data collections from any device that is connected to the cloud.

The cloud synchronization module can use the compression and backup module for moving and/or copying a user's collections to the cloud (networked location or locations accessed over the Internet) such that the user accesses the exact same collection from any of his devices. The presentation module may present a collection differently on different devices in accordance with a device's form and capabilities, but the underlying content accesses (collection) is one, the version stored in the cloud.

In another aspect, the present invention relates to a computerized, multimedia, collection-based presentation system comprising a processor and memory, comprising:

(i) a data identifier module for scanning multimedia data items on one or more devices and arranging said multimedia data by collections based on predetermined collection-related parameters;

(ii) a data filtering module for removing multimedia data items that are deemed unnecessary; and

(iii) a data packager module for packaging together all multimedia data items relevant to a collection such that all said multimedia data items can be viewed together.

The above embodiment may also comprise a cloud synchronization module as described above.

In a further aspect, the present invention relates to a computerized, multimedia, collection-based presentation system comprising a processor and memory, comprising a data identifier module for scanning multimedia data items on one or more devices and arranging said multimedia data in a database by collections based on predetermined collection-related parameters.

The above embodiment may also comprise a cloud synchronization module as described above.

In yet another aspect, the present invention relates to a computerized, multimedia, collection-based presentation system comprising a processor and memory, comprising a display module for displaying multimedia data items of different types relevant to a collection according to a predetermined presentation template.

The above embodiment may also comprise a cloud synchronization module as described above.

In yet a further aspect, the present invention relates to a computerized, multimedia, collection-based presentation method, comprising the steps of:

(i) scanning multimedia data items on one or more devices and arranging said multimedia data items in a database by collections based on predetermined collection-related parameters, said scanning performed by a processor on multimedia data in memory;

(ii) removing multimedia data items that is deemed unnecessary, said removing performed by a processor on multimedia data in memory;

(iii) packaging together all multimedia data items relevant to a collection, said packaging performed by a processor on multimedia data in memory; and

(iv) displaying said multimedia data items relevant to a collection according to a predetermined presentation template, said displaying performed by a processor on multimedia data in memory.

The above method may also comprise a step of cloud synchronization as described above.

### BRIEF DESCRIPTION OF DRAWINGS

FIG. 1 is a general block diagram of an embodiment of a system for scanning, filtering, packaging and displaying multimedia data items according to some embodiments of the invention.

FIG. 2 is a detailed flow diagram of a process for scanning, filtering, packaging and displaying multimedia data items according to some embodiments of the invention.

FIG. 3 is a screen shot of an example of a display on a mobile phone according to the invention.

FIG. 4 is a screen shot of an example of a display on a mobile phone according to the invention.

FIG. 5 is a screen shot of an example of a display on a tablet according to the invention.

FIG. 6 is a screen shot of an example of a display on a tablet according to the invention.

FIG. 7 is a screen shot of an example of a display on the Web according to the invention.

FIG. 8 is a screen shot of an example of a display on the Web according to the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a new type of media that creates an all-in-one experience by combining media (photos, videos, etc.), content (text, external feeds) and meta-data (tagged friends, location) into one interactive canvas in an automatic manner. An application of the invention can run on any user device: mobile device, personal computer, tablet, laptop, game console, TV or any other computing device that can store or access content and can run or even just display applications.

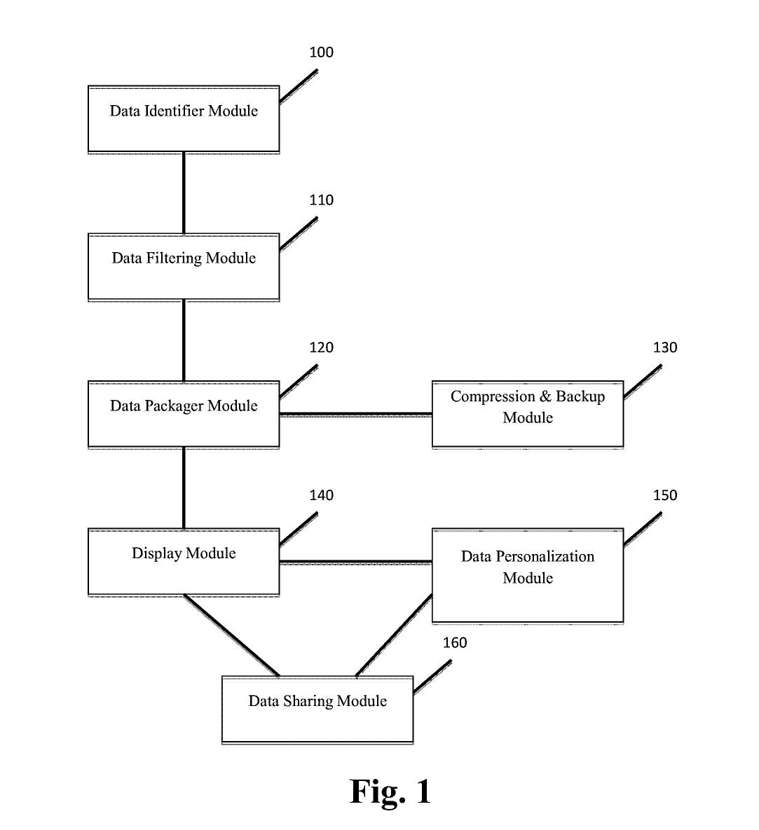

FIG. 1 is a general block diagram of an embodiment of a system of the invention.

In one aspect the present invention relates to a computerized data identifier module 100 for scanning multimedia data on one or more devices (or networked storage such as the cloud) and arranging said multimedia data by collections based on predetermined collection-related parameters. The selection of multimedia data items into groups, each group representing a collection, can be an automatic process of the system or a process controlled by the user. It is also possible to start with an automatic selection by the system which is then customized by a user. Another alternative is to enable the user to custom select all the multimedia items related to a collection.

A data filtering module 110 then can be activated in order to eliminate multimedia items that will not be part of the collection. The filtering criteria include but are not limited to blurry images, duplicate images (can also be based on time between images), too dark or too bright images, very short videos, very long videos, content that is deemed private or intimate etc. This process can be an automatic process of the system, a process controlled by the user, or an automatic process that later can be modified by the user.

After all the multimedia items related to a collection are identified and selected, a data packager module 120 packages together all multimedia data relevant to a collection. The packaged multimedia items relevant to a collection are called a “flayvr”.

Optionally, a compression and backup module 130 can be activated in order to optionally compress the created collection (flayvr) and to back it up either to a predetermined location or to a location selected by the user. The backup can be done gradually to provide a quicker experience. First the system will upload smartly compressed media, and then gradually upload the media in better quality.

In another aspect, the present invention relates to a display module 140 for displaying said multimedia data relevant to a collection according to a predetermined presentation template which is the specific template that is the most relevant and engaging template based on the data within the flayvr. Once a user views the different multimedia data of a collection the user can interact with the content, for example, view a video, enlarge an image, read text, tag friends, add information to a content piece (location, time of capture, remarks etc.) or share the content with other users using the data sharing module 160. Sharing content can be done via email, Short Messages (SMS), Multimedia Messages (MMS) or social networks such as Facebook™, Twitter™, WhatsApp™, LinkedIn™etc. Sharing can also be done from within an application of the invention with other users that are using the same application on similar platforms. These users can then view the flayvr and even add, whether directly or automatically, multimedia or metadata of their own, to create a shared flayvr. It is important to note that sharing is done either for each data item on its own or for the entire flayvr itself. While sharing, users can edit the group in manners such as filtering out images and changing the data.

The data personalization module 150 allows the user to personalize the display of a flayvr using different methods:

Change or add a title or a location to the flayvr

Add or remove any media from the flayvr

Select a theme or a color to the flayvr.

Add media, internal, new or from 3^{rd} parties

Change the order of the media presented

Select a new layout (such as the number of tiles, layout on the screen, etc.)

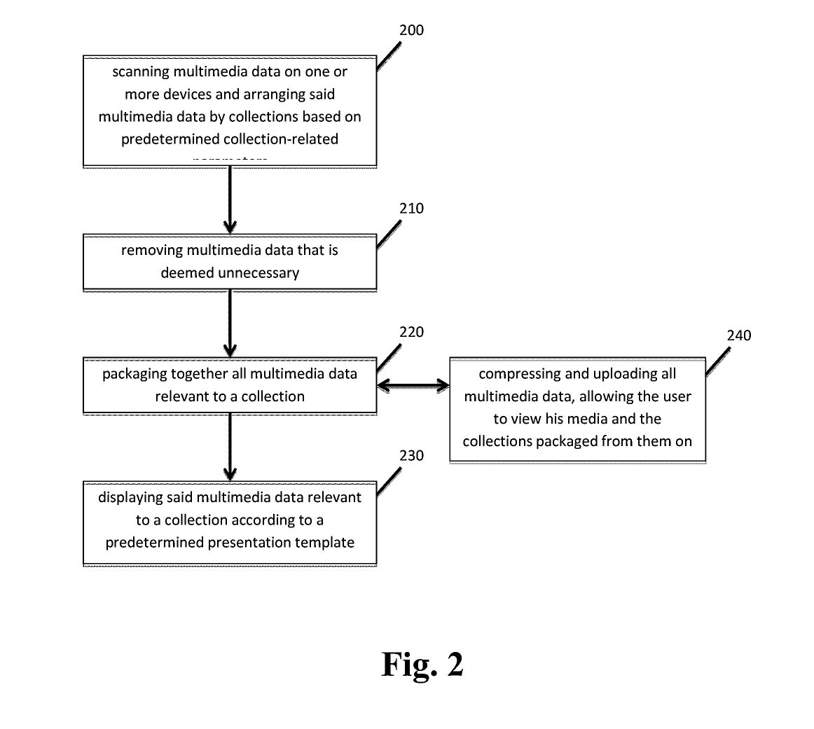

FIG. 2 is a detailed flow diagram of a process for scanning, filtering, packaging and displaying multimedia data items according to some embodiments of the invention.

Step 200 includes scanning multimedia data on one or more devices (including on network storage locations) and arranging said multimedia data by collections based on predetermined collection-related parameters. The selection of multimedia data items into groups, each group representing a collection, can be an automatic process of the system or a process controlled by the user. It is also possible to start with an automatic selection by the system which is then customized by a user. Another alternative is to enable the user to custom select all the multimedia items related to a collection.

Step 210 includes removing multimedia data that is deemed unnecessary, including but are not limited to blurry images, duplicate images (can also be based on time between images), too dark or too bright images, very short videos, very long videos, content that is deemed private or intimate etc.

Step 220 includes packaging together all multimedia data relevant to a collection.

Optional step 230 includes compressing and uploading all multimedia data for backup purposes either to a predetermined location or to a location selected by the user.

Step 240 includes displaying said multimedia data relevant to a collection according to a predetermined presentation template. Once a user views the different multimedia data of a collection the user can interact with the content, for example, view a video, enlarge an image, read text, tag friends, add information to a content piece (location, time of capture, remarks etc.) or share the content with other users. Sharing content can be done via email, Short Messages (SMS), Multimedia Messages (MMS) or social networks such as Facebook™, Twitter™, WhatsApp™, LinkedIn™ etc. Sharing can also be done from within an application of the invention with other users that are using the same application on similar platforms. These users can then view the flayvr and even add, whether directly or automatically, multimedia or metadata of their own, to create a shared flayvr. It is important to note that sharing is done either for each data item on its own or for the entire flayvr itself. While sharing, users can edit the group in manners such as filtering out images and changing the data. These modifications to the display can be done, for instance, by providing a user interface of an application installed at the user's end device, the user interface being configured for allowing the user to modify the specific display of the specific data collection and/or for modifying one or more available presentation templates.

In some embodiments, the flow of an application of the invention can go as follows:
1. Home screen—users have two options to create flayvrs.
   a. Selecting one of the flayvrs that were auto-packaged by the data packaging module 120 of the invention (see below for more).
   b. Starting a new flayvr—starting to take photos and videos and building a flayvr on the fly or selecting media items based on their own wishes.
2. Flayvr Player
   a. The flayvr begins to play on the screen using the display module 140. The user can select to zoom in on any tile, swipe between images, view the videos and zoom-in on them.
3. Edit
   a. User can select to edit and personalize the flayvr: remove unwanted media by the data filtering module 110, select a theme or colors, add 3^{rd} party media such as songs, images, backgrounds, etc. using the data personalization module 150.
4. Share
   a. Share this flayvr with other users within the flayvr network or externally via email, SMS, MMS, social networks etc using the data sharing module 160.

The Flayvr Itself

The flayvr structure comprises the media itself, which can be separated into different tiles, the different actions such as editing or sharing, the comments, the friends, the location, discovery of other flayvrs, etc. Each tile can be of a certain type but tiles may also include different types of media items or content.

The selection of how to arrange the flayvr in terms of what to put inside each tile is done automatically by the system based on different parameters such as the orientation of the media, the amount of content, the personalization selected, etc. Even the number of tiles is not set and can be decided automatically by flayvr or by the user in some cases.

The flayvr itself looks similar no matter which platform it's presented on—mobile, web, tablet, desktop, game console, TV set-top box etc. but it can be adjusted to fit the platform specifically.

Automatic Packaging

Auto-packaging comprises (i) a data identifier module 100 for scanning multimedia data on one or more user devices and/or networked storage areas (such as the Cloud) and arranging said multimedia data by collections based on predetermined collection-related parameters; (ii) a data filtering module 110 for removing multimedia data that is deemed unnecessary; and (iii) a data packager module 120 for packaging together all multimedia data relevant to a collection.

Once an application of the invention is available on a user device (downloaded and installed, preinstalled, accessed as a service of the network etc.), the data identifier module 100 automatically scans, in real-time, the media that is stored on the user device, connects to external sources such as social networks, and arranges the media into collections based on predetermined collection-related parameters such as:
Location of the multimedia data was captured;
Time and date when the multimedia data was captured (e.g.—afternoon on May 15^{th});
Orientation;
Pattern and frequency of media capturing (e.g. 30 minutes idle period might signal a new event);
Tagged friends, or people that are automatically recognized in the media by flayvr;
User's profile data, gathered from different external sources, or recognized automatically by flayvr (e.g. if the user always takes pictures in NY and is now in Chicago for the weekend, the system can automatically create a “weekend in Chicago” event. Or if the user is known to live in a specific city, and is now taking photos in another city, the system can create an event from all these photos);
Participant data (e.g. the system receives a signal that it has 30 photos of Mike and creates a flayvr for him);
Data about the user that is gathered from external sources (e.g. events that the user is attending in Facebook™, or events from his calendar)
Predetermined events determined by the system, events or time spans determined by the system (monthly flayvr, 4^{th} of July flayvr, etc.)
Similar media items identified over a certain period of time (such as all photos that include dogs)
Events that have been created by friends using an application of the invention and were shared with the user (eg. a flayvr shared by user A with user B, where user B has photos or videos that fit the criteria, such as time, that was set by user A as the flayvr parameter).

As part of creating the package, different algorithms automatically filter out media that should be ignored. This includes blurry images, duplicate images (can also be based on time between images), too dark or too bright images, very short videos, very long videos, content that is deemed private or intimate etc.

Part of the auto-packaging can also include auto-tagging and giving auto-titles to the experiences. This is achieved by connecting to the user's social stream on 3^{rd} party networks. For example, if the user marked, on a social network, that he is “attending” Mike's birthday—the system will automatically identify the media taken on this date and time and title that flayvr as such.

Personalization

Users can choose to personalize the display of a flayvr by the data personalization module 150 using different methods:

Change or add a title or a location to the flayvr.

Add or remove any media from the flayvr.

Select a theme or a color to the flayvr.

Add media, internal, new or from 3^{rd} parties

Change the order of the media presented

Select a new layout (such as the number of tiles, layout on the screen, etc.)

Sharing and Following

Flayvrs are shared by the data sharing module 160 on different methods and can be viewed on any platform, whether it's social networks, email, SMS, MMS or others. Sharing can also be done internally from within a network, connecting flayvr applications of the invention running on different devices/network storage and/or by different users. Users may be able to follow each other's flayvrs, share, comment, create collaborative flayvrs and interact.

Dynamic

Any change or edit to the flayvr can automatically be saved on a cloud server and is then reflected in near real time (or when possible) on the different instances of the flayvr, be it on the web or in an application. This means that a user can edit out media, add media, personalize the flayvr, tag new friends, etc. in real-time or near real-time.

Search

The users' media and the different collections that are packaged automatically by flayvr can be searched on or filtered, according to different parameters, such as:
Location of the multimedia data was captured;
Time and date when the multimedia data was captured (e.g.—afternoon on May 15^{th});
Tagged friends, or people that are automatically recognized in the media by flayvr; or
Texts or tags that were added to the media or the collections (either manually by the user or his friends, or automatically by flayvr).

Contextual Discovery

Each flayvr created by users is automatically linked within the system to other flayvrs that are related to it. These can be flayvrs which are:
Created in the same event;
Are in the same area;
Created by the user's friends or by the viewers' friends;
Related advertisements
Created by the same user in some other time in the past; or
Have some sort of tagging/textual relationship (e.g.—both were created in a flea market, even if each one is in a different type of the world).

A user which views one flayvr, can choose to continue on (from within the flayvr itself) to the next flayvr from a never-ending pool of related flayvrs suggested by the system. Moreover, flayvr can automatically create (permission based) a single flayvr that includes media from different users.

Contextual discovery allows a user to start off with one of his friend's flayvrs, view them and then continue to enjoy and discover related flayvrs based on mutual friends, location of the events themselves, time and date and context which is derived from the texts. This contextual discovery can also lead to “promoted flayvrs” which are essentially advertisements presented in the manner of a flayvr.

The system can also automatically inform the user of flayvrs that are contextually related to him at a given moment. These can be flayvrs from media he captured in the past, flayvrs that were shared with him, flayvrs of other people that relate to him, or flayvrs which are essentially advertisements. E.g., if a user travels to N.Y., the system can inform him of a flayvr he took in N.Y. a few years ago, or a flayvr from N.Y. that a friend of his shared with him, or a flayvr that is an advertisement showing activities to do around N.Y.

Cross Platform Sharing

Flayvrs can be created in a cross-platform way (such as HTML5, Flash, or any other present or future technology also including sharing content across network storage such as the cloud) that is on one hand dynamic and on the other hand widely supported on different platforms. This allows for sharing on any platform and for creation on any platform.

Tile Types

In some embodiments, the display module can display a flayvr using tiles of different types. Since the display module is dynamic it is possible to add more tile types in the future, which can be integrated into the flayvr itself. This can include:

E-commerce tile

Reservation (like restaurant reservation)

Twitter feed (or any other feed from social networks)

Map tile

Etc.

Backup & Cross Platform Viewing

The users' media can be backed-up by the compression and backup module 130 to some cloud storage (either proprietary or of a 3^{rd} party). This allows the user to view his media and the collections packaged from them on any platform and any device (mobile phone, a tablet, a personal computer, a laptop, a game console, a TV set-top box or any other mobile device). E.g., he can view on his iPad the photos he took earlier with his iPhone.

The backup can be done gradually to provide a quicker experience. First the system will upload smartly compressed media, and gradually upload the media in better quality. Alternatively, the backup can be done to a location selected by the user.

How Does It Work

Automatic Packaging

When the system is launched by the user, the data identifier module 100 scans for multimedia data items and content (such as photos, videos, social media posts, friends, calling history) that are stored on the user's device and network storage and also from outside sources that fill in information and media (such as check-ins on social networks, or confirmation for attending certain event).

Next, the data filtering module 110 removes multimedia data that is deemed unnecessary, such as duplicates, blurry images, too short videos, inappropriate content etc.

Finally, the data packager module 120 packages together all multimedia data relevant to an event into a flayvr.

The display module 140 can the display the multimedia data relevant to an event (flayvr) according to a predetermined presentation template. The flayvr is displayed using a smart collection on the screen, capturing the user experience of that event.

In-order to determine what an experience is, and in-order to differentiate between experiences, the data identifier module 100 analyzes the related meta data that is part of the multimedia data, and finds patterns that the media and content can be combined based on. These patterns can rely on any or all of the above mentioned media and content. The idea is to have all of the relevant media and content which relates to an event in one place, and collect it automatically.

In order to package an experience the minimal mandatory inputs are: user's photos or videos. Based on some optional piece of known meta data about the media, grouping can be improved (this can be any or all such as: orientation, time, date, tagged friends, location they were taken). Once meta data is identified, some patterns and characteristics can be identified (such as photos that were taken within a certain range of time and that there are no photos that in between the user didn't take any pictures for X minutes. Or: photos taken with a certain location).

Once a flayvr is created for an event, additional external information can optionally be added to strengthen the experience, as mentioned earlier.

For example, a user might attend a music concert and take pictures and videos there using any camera, whether if through the flayvr application or through a phone or any device's camera. At the same time, the user might post on social networks (such as a tweet on Twitter™) his reflections from the show, and at the same time the user's friend will also take her own pictures. In this case, the system will notice that the user has taken 30 pictures or videos within the past 2 hours, all within a certain location that it recognized automatically from the information attached to the pictures. It will notice on Facebook™ that the user notified he was attending the concert and retrieve the name of the artist from it. The system will then group this media and content together and present it to the user in the manner specified below, as a single packaged experience. The system may then automatically or based on the user's actions share this flayvr with the user's friend, who may then automatically or manually add her own media or comments to the same album.

In another example, the user might go on a hike and take 25 photos and videos. After an hour or so, once the user is back home, he will go to attend a birthday party and take more photos/video thus producing more media content. The data identifier module will recognize that the user has returned to his home (by knowing the user's behavioral habits) and that he is now no longer on a trip. The data identifier module will therefore identify the trip and the party separately as 2 different events/experiences, but the display module will allow the user to combine these events as one.

Automated Flayvr Creation

Media Selection

When first presenting a flayvr to the user, prior to providing him the option to view it, the display module 140 also selects which elements of the packaged multimedia data to present to the user and which to hide. The final presented media can be a subset of the packaged media combined with elements taken from 3^{rd} parties (over the Internet, social networks, friends' content etc.). The hidden elements (such as photos that blurred) can later on be un-hidden by the user.

In some embodiments, by default, all the packaged media is presented except for items excluded by the data filtering module. The data filtering module 110 is responsible for:
Removal of bad images and videos—3^{rd} party and proprietary algorithms can be used to identify if certain images and videos are blurry, too dark, too light, or in case of video—too shaky or too short or too long.
Duplicates—the data filtering module recognizes when certain media was taken within a short time period and will remove duplicates or select the best image (according to the same algorithms mentioned above) to be presented.
Removal of content that is deemed private or inappropriate such as nudity.

Layout

In some embodiments, the display module 140 automatically selects the layout to display a flayvr by using a predetermined presentation template. The display module 140 considers the subset of multimedia data items (typically but not exclusively images and videos) that were not selected as hidden elements not to be displayed. The display module selects a presentation template from a selection of presentation templates that are available in the system. The presentation template selection is done based on the following data (all optional): orientation of the photos and videos, number of photos and videos in the collection, time of day when media was taken, history of selection of templates for the user, etc.

For example, if the event flayvr includes only 5 photos, the display module 140 might select a presentation template that presents to the user only 3 images at each time. If the event flayvr also includes, in addition, a video, the display module 140 might select a presentation template where the video is highlighted.

For this purpose, each presentation template can be composed of a different number of tiles (usually 4-10 tiles) in which the content of can change based on the identified multimedia data and content. Each tile may include one or more content types such as: photos, video, title, date, time, user's profile image, advertisement, map, sound clip, music video, etc.

The content of each tile may change automatically by the system (fade) or may be changed by the user as part of his editing. It is possible that a certain tile will present content that is also duplicated on another tile.

Tiles may also move and resize, making the layout dynamic. In this sense some tiles may be combined with others as the flayvr continues to change.

In-order to select which tile to present with which content, the display module can use information that is derived from analytical data that is collected by the system and thus identify which layouts solicit the most interaction from the user. Interaction is measured as when the user clicks on a tile, views its content or does some other action within the tile such as swiping it. Presentation templates that receive the most interaction from users in aggregate will be used more than other templates. In addition, for a specific collection, the layout may change from each time the user views it, based on the interactions which he performed within the system itself, and based on the interactions which his friends performed.

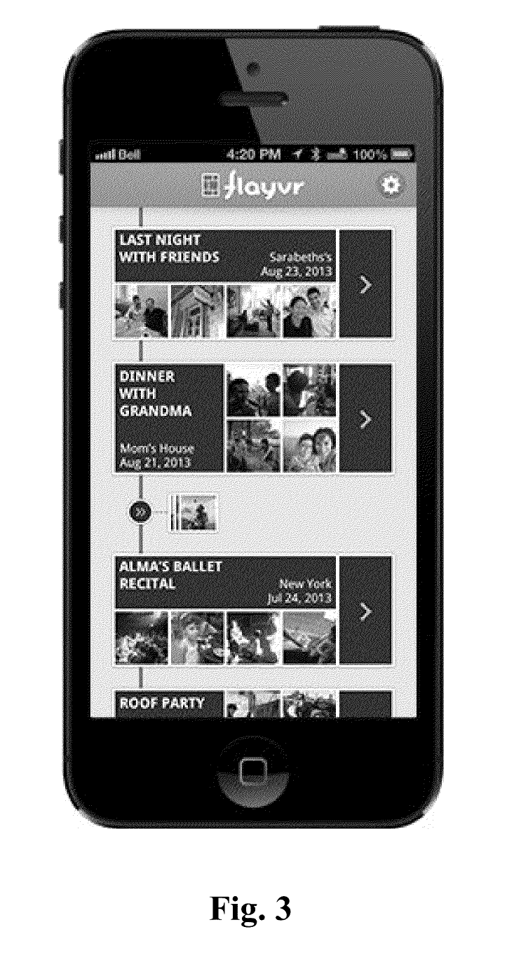

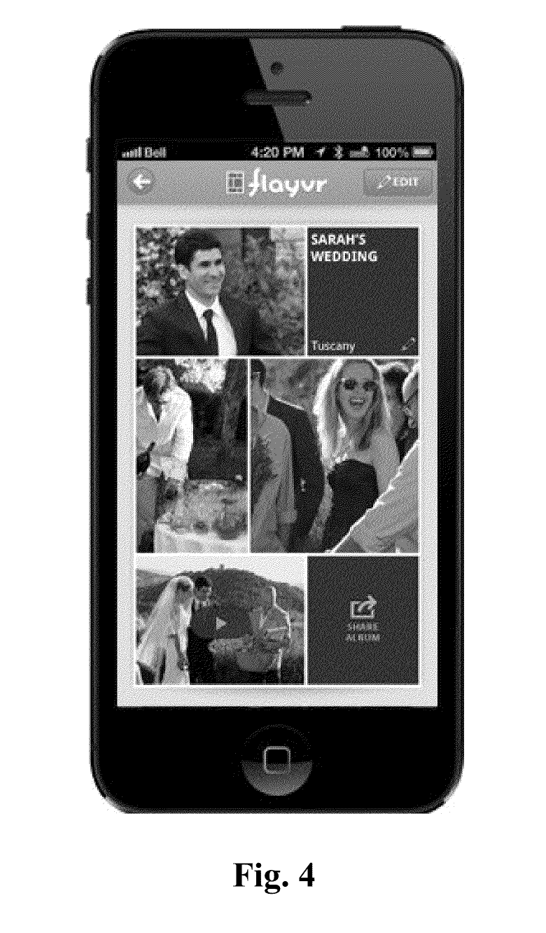

FIGS. 3 and 4 illustrate examples of collections (flayvr's) displayed on a mobile phone. FIG. 3 is a screenshot showing several different collections on the same screen, each collection showing multiple photos and including the location and date when the photos were taken. FIG. 4 is a screenshot of one collection (flayvr) of Sarah's wedding in Tuscany showing on the screen 3 photos and one video. Every photo or video in a collection is displayed on its own tile.

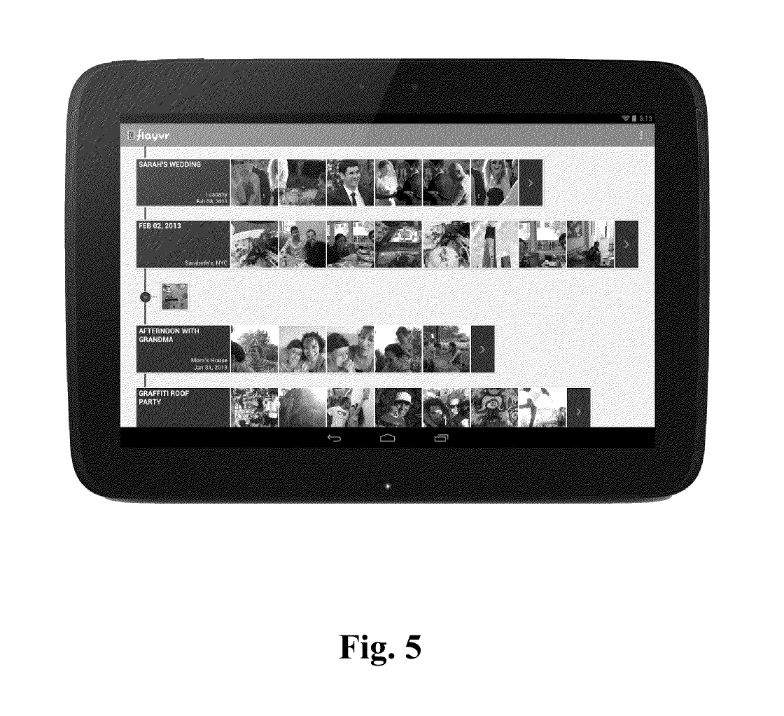

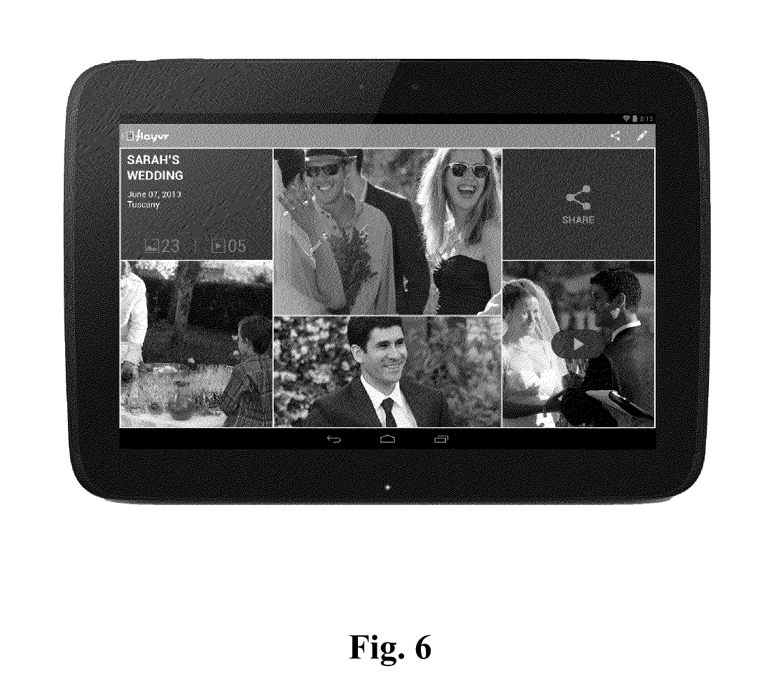

FIGS. 5 and 6 illustrate examples of collections displayed on a tablet, using a custom application of the invention running on the device. FIG. 5 is an example of displaying multiple collections, while in FIG. 6 a single collection is displayed, the pictures and video being thus displayed on larger tiles.

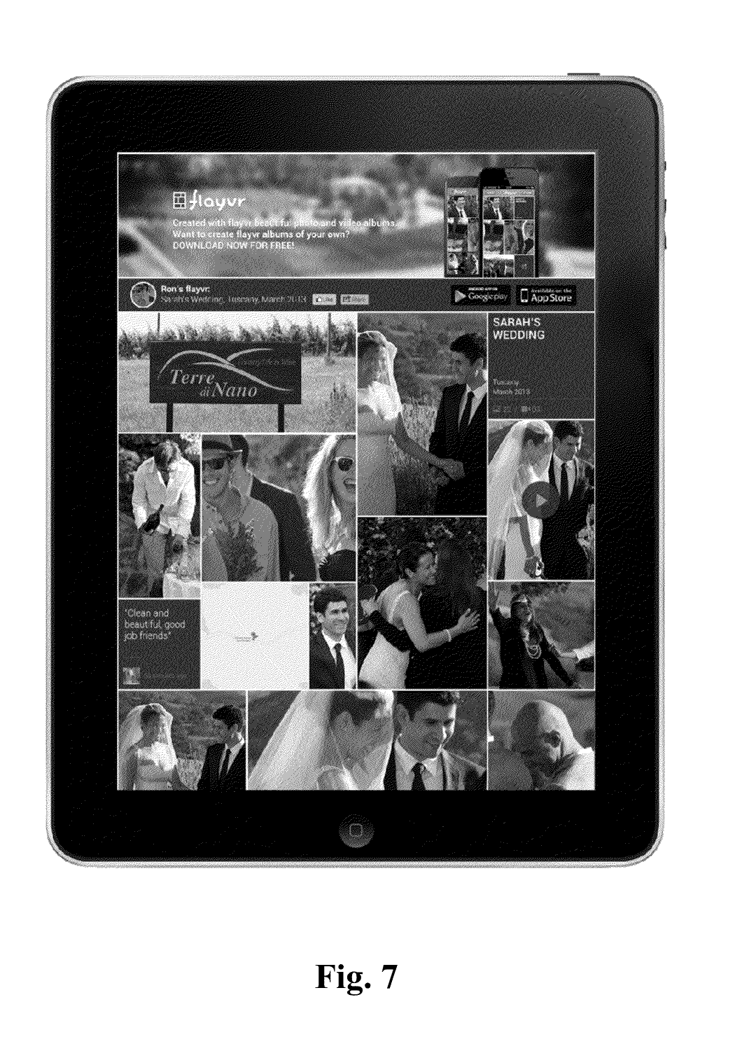

FIG. 7 illustrates an example of a collection displayed on a tablet device through a browser, thus the collection is retrieved from a networked location (i.e. cloud) and displayed on a browser. FIG. 7 illustrates additional content displayed besides photos and video, such as a maps and user comments.

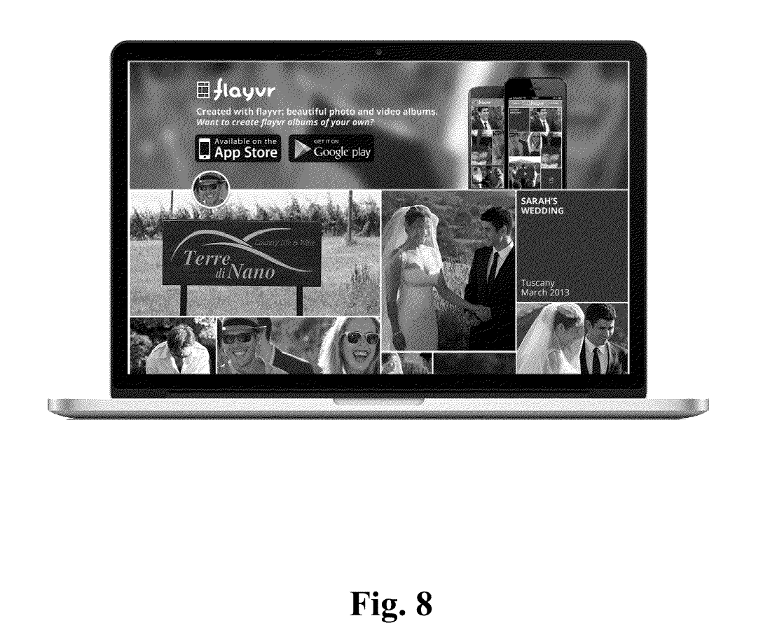

FIG. 8 illustrates an example of a collection displayed on a personal computer screen through a browser, thus the collection is retrieved from a networked location (i.e. cloud) and displayed on a browser.

Additional Automation

The display module 140 may add additional automatic processes as part of creating the layout:
Auto-title a collection: the display module may recognize that it has additional meta information that was derived from the extrapolation on the pictures themselves or from 3^{rd} party networks such as social networks or from the user's calendar on the device, and may decide to title the event as such. For example, if the user's calendar includes a meeting at 5 PM, which is the time at which images started to appear in the collection, then the system might create a flayvr by the title of the meeting that appears in the calendar. Another example may be that the user has notified that he attending an event ion Facebook™, in which case the event's name will be selected as the flayvr itself.
Identify location: the display module may also set the flayvr's location to a precise location, even if the user hasn't performed an action of mentioning in which exact address he appears. For example, if the user has checked-in at a place on a social network such a foursquare, at the same time that the collection appear, and the system has connected to the social network—the display module will search for check-ins during this time period and will automatically set the flayvr location as such. In this manner, instead of having a collection of which location is set to “New York”, the display module can determine it was done specifically at “Katz's Deli” in New York.

Auto-Tagging of Friends

In some embodiments, the system uses 3^{rd} party interfaces such as those provided by face.com to automatically identify which of the user's friends appear in a flayvr and automatically tag them as part of the experience. The list of friends is derived through a connection to the user's social networks. The friends' names are then used as part of the meta data that comprises the collection.

### Server Functionalities

The application on the device can work both as an independent device-only application (on a mobile phone, tablet, PC etc.) or in some embodiments, the device application can be connected to a centralized server of the invention.

The server of the invention can have several functionalities, for example:

Storage—a user can load all the multimedia content items into a server and then demand to view them from a device, wherein the display application accesses the content stored in a server of the invention.

Content presentation—the server can serve a client application (device application, web application, browser) the flayvr itself with the right presentation template.

Analytics—the server can collect usage statistics and analytics in order to detect user preferences and improve the success of future flayvrs with users.

It is important to notice that any functionality of the invention described herein (data identification, filtering, packaging, display etc.) can done exclusively by a device application, exclusively by a server, or the functionalities can be divided in any way by the device application (client) and the server. For example, some functionalities like data storage can be done exclusively by the server while all the other functionalities are handled by the device application. Alternatively, some functionalities can be handled both by the device application and the server, for example, the server can serve the content saved by the user while the device application fetches content stored on 3^{rd} party locations.

When the flayvrs are stored on the server it is easy for a user to share them, since the user does not need to send the actual data but only need to share a link to the right flayvr on the server.

In some embodiments, any or all of the functionalities of the data identifier module, data filtering module, data packaging module or data display module reside on a server connected to an application on a user device. The server can handle exclusively one such functionality or such functionality can be shared between the server and a device application (client).

### Push Notifications

In some embodiments, notifications are presented to the user in case that the application of the invention is not in the foreground in a user device. The purpose of these notifications is to prompt the user to create more event flayvrs and to visit the application in order to view and share them. Push notifications can originate from a backend system (the server side) which receives information from the app in real time and based on algorithms that are similar to the packaging algorithms mentioned above, groups media items into flayvrs, or can be created by the app itself, through monitoring of the user's actions or any other environmental or technical changes in the background and notifying when the right time to send a push notification is.

Server Notifications:

These are generic notification in which case a server of the invention knows, based on generic behavior that is presented by other users, or based on marketing decisions, that there is a good chance that if the user visits the application now, he will create and share more flayvrs. These can be, for example, notifications that are time and date related such as holidays, special events, new months, etc. Examples can include: back to school, beginning of the month, 4^{th} of July, valentine's days, etc.

In certain cases, server notifications can also stem from the fact that the server (backend) ran an algorithm that profiled the user's behavior and saw when it is likely for him to take photos and videos. For example, a user that takes photos every weekend will be promoted to view them on Monday morning.

The backend server can also connect to 3^{rd} party applications which the user has given the permission to, such as cloud-based photo management services, social networks, etc. In these cases the backend will identify that the user has uploaded photos to these services and will prompt him to create flayvrs out of them.

Application Originated Notifications

The application of the invention (running on a user device) can run in the background and sense when there are new flayvrs ready to be viewed or shared. For example, the application can sense that the user has taken 4 photos and thus prompt him that the flayvr is ready for viewing. The application may also recognize that the user is in a certain location that is different from his usual whereabouts and will prompt him to view that moment. For example, the application may recognize that during most of the days the user is New York, but suddenly that he is in San Francisco for a few days, and will create his “ San Francisco vacation” flayvr.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

1. A computerized, multimedia, collection-based presentation system comprising a processor and memory, comprising:
(i) a data identifier module for scanning multimedia data items on one or more devices and arranging said multimedia data in a database by collections based on predetermined collection-related parameters;
(ii) a data packager module for packaging together all multimedia data items relevant to a collection; and
(iii) a display module for displaying said multimedia data items relevant to a collection according to a predetermined presentation template.

2. The presentation system according to claim 1, wherein said multimedia data items comprise, images, video clips, sound clips, text, maps or advertisements.

3. The presentation system according to claim 1, further comprising a data filtering module for removing multimedia data items that are deemed unnecessary;

4. The presentation system according to claim 3, wherein said data filtering module removes blurry images, duplicate images, too dark or too bright images, very short videos, very long videos, shaky videos, content deemed private, inappropriate or intimate, or multimedia data deemed of low quality.

5. The presentation system according to claim 1, wherein said collection-related parameters comprise: location where said multimedia data was captured, time when said multimedia data was captured, orientation, pattern of media capturing, tagged friends, user profile data, participant data, predetermined collections determined by the system.

6. The presentation system according to claim 1, wherein said presentation template comprises a plurality of tiles, each tile displaying a multimedia data item.

7. The presentation system according to claim 6, wherein the display module is configured to display on each tile a multimedia data item for a given period of time after which another multimedia data item from the same collection is displayed on said tile.

8. The presentation system according to claim 6, wherein each tile can also display an advertisement, a map, the date, a time, user profile data or a sound clip.

9. The presentation system according to claim 6, wherein the display module is coupled to a user interface configured for changing the content of a tile following a user action.

10. The presentation system according to claim 1, wherein the display module displays a multimedia data item of the relevant multimedia data in a tile based on analytical or statistical data regarding which presentation template gained the most interaction from a user.

11. The presentation system according to claim 10, wherein said interaction is measured when a user clicks on the tile, views the content of the tile, moves the tile, changes the position of the tile, selects the tile or performs any other action specific to said tile.

12. The presentation system according to claim 1, wherein said display module is further configured for automatically deriving a collection title of a particular packaged multimedia data item by analyzing user related data on a device or external sources or both.

13. The presentation system according to claim 12, wherein said external sources are social networks, external databases or any other available data.

14. The presentation system according to claim 1, wherein said data identifier module is further configured for accessing and retrieving multimedia data items from external sources.

15. The presentation system according to claim 1, further comprising a data sharing module configured to sharing multimedia data items relevant to a collection with other users.

16. The presentation system according to claim 15, wherein said data sharing module is configured for sharing multimedia data items via email, Short Messages (SMS), Multimedia Messages (MMS) or social networks.

17. The presentation system according to claim 1, wherein any or all of the functionalities of the data identifier module, data filtering module, data packaging module or data display module reside on a server connected to an application on a user device.

18. The presentation system according to claim 17, wherein said user device is a mobile phone, a tablet, a personal computer, a laptop, a game console, a TV set-top box or any other mobile device.

19. The presentation system according to claim 17, wherein said user device is a networked storage location.

20. The presentation system according to claim 1, further comprising a cloud synchronization module adapted for storing multimedia data collections in the cloud such that the display module can access said multimedia data collections from any device that is connected to the cloud. (Original) A computerized, multimedia, collection-based presentation system comprising a processor and memory, comprising:
(i) a data identifier module for scanning multimedia data items by the processor on one or more devices and arranging said multimedia data in a database by collections based on predetermined collection-related parameters;
(ii) a data filtering module for removing by the processor multimedia data items that are deemed unnecessary; and
(iii) a data packager module for packaging together by the processor all multimedia data items relevant to a collection such that all said multimedia data can be viewed together.

21. The presentation system according to claim 21, further comprising a cloud synchronization module adapted for storing multimedia data collections in the cloud such that the display module can access said multimedia data collections from any device that is connected to the cloud.

23.-26. (canceled)

27. A computerized, multimedia, collection-based presentation method comprising a processor and memory, comprising the steps of:
(i) scanning multimedia data items on one or more devices and arranging said multimedia data items in a database by collections based on predetermined collection-related parameters, said scanning performed by a processor on multimedia data in memory;
(ii) removing multimedia data items that is deemed unnecessary, said removing performed by a processor on multimedia data in memory, said removing performed by a processor;
(iii) packaging together all multimedia data items relevant to a collection, said packaging performed by a processor on multimedia data in memory; and
(iv) displaying said multimedia data items relevant to a collection according to a predetermined presentation template, said displaying performed by a processor on multimedia data in memory.

28. The presentation method according to claim 27, further comprising the step of cloud synchronization for storing multimedia data collections in the cloud and displaying and accessing said multimedia data collections from any device that is connected to the cloud.
